(19) United States
(12) Patent Application Publication
(10) Pub. No.: US 2026/0057150 A1
(43) Pub. Date: Feb. 26, 2026

(54) SEMICONDUCTOR YIELD PREDICTION MODEL ANALYSIS METHOD AND SYSTEM

(71) Applicant: Samsung Electronics Co., Ltd., Suwon-si (KR)

(72) Inventors: Kyoung Won KANG, Suwon-si (KR); Jung Hee KIM, Suwon-si (KR); Sun Jae LEE, Suwon-si (KR)

(73) Assignee: Samsung Electronics Co., Ltd., Suwon-si (KR)

(21) Appl. No.: 19/033,858

(22) Filed: Jan. 22, 2025

(30) Foreign Application Priority Data
Aug. 20, 2024 (KR) 10-2024-0111445

(51) Int. Cl. G06F 30/27; G06F 119/22

(52) U.S. Cl. CPC G06F 30/27; G06F 2119/22

(57) ABSTRACT

A semiconductor yield prediction model analysis method according to one embodiment of the present disclosure may be performed by a computing device, and may comprise selecting a plurality of models having a prediction accuracy exceeding a preset threshold value, wherein each of the plurality of models is an artificial intelligence model configured to receive semiconductor-related data as a predictive factor and predict a semiconductor yield using the predictive factor; selecting a plurality of predictive factors commonly included in the plurality of models; obtaining a prediction contribution of each of the selected plurality of predictive factors to a prediction result of each of the plurality of models; scaling the prediction contributions of the predictive factors obtained on each of the models so as to be within the same range; and calculating a contribution rank of each of the selected plurality of predictive factors based on the scaled prediction contributions.

### CROSS-REFERENCE TO RELATED APPLICATION

This application claims priority from Korean Patent Application No. 10-2024-0111445 filed on Aug. 20, 2024 in the Korean Intellectual Property Office, and all the benefits accruing therefrom under 35 U.S.C. 119, the contents of which are herein incorporated by reference in their entirety.

### BACKGROUND

### Field

The present disclosure relates to a semiconductor yield prediction model analysis method and system, and more specifically, to a method and system for analyzing a contribution rank of a predictive factor to a prediction result of each of various artificial intelligence models for predicting a semiconductor yield based on explainable artificial intelligence.

### Description of Related Art

A semiconductor device is attracting attention as an important element in the electronics industry due to characteristics thereof such as miniaturization, multi-functionality, and/or low manufacturing cost. The semiconductor devices may be classified into a semiconductor memory device that store logic data therein, a semiconductor logic device that performs computational processing of logic data, and a hybrid semiconductor device including a memory element and a logic element. As the electronics industry is highly developed, demand on the beneficial characteristics of the semiconductor device is also increasing. For example, the demand for high reliability, high speed, and/or multi-functionality of the semiconductor device is increasing. To meet these demands, structures within the semiconductor device are becoming increasingly complex, and furthermore, the semiconductor device is becoming more highly integrated.

A semiconductor yield refers to a percentage of a defect-free product, and is expressed as a percentage of the number of actually produced normal chips relative to the maximum number of chips designed on one wafer. Various factors may affect the semiconductor yield, and improving the yield is very important in the semiconductor manufacturing process. To this end, many studies have been conducted on artificial intelligence models to predict the semiconductor yield based on various factors included in semiconductor equipment and the process data. Furthermore, with the introduction of explainable artificial intelligence (eXplainable AI; XAI), research on a contribution of each factor to the semiconductor yield prediction in the model has been conducted. However, since a prediction contribution calculated from a single artificial intelligence model cannot be applied to all semiconductor manufacturing processes, research is being performed to collect the prediction contributions as calculated from various artificial intelligence models and ultimately to determine the factor affecting the semiconductor yield based on the collection.

### SUMMARY

A technical purpose to be achieved according to embodiments of the present disclosure is to provide a method and system for analyzing a contribution rank of a predictive factor calculated by applying a SHAP (Shapley Additive exPlanations) algorithm to each of various artificial intelligence models for predicting a semiconductor yield, based on explainable artificial intelligence.

In addition, a technical purpose to be achieved according to embodiments of the present disclosure is to provide a method and system for grouping predictive factors used for predicting a semiconductor yield into groups, based on a type of the predictive factor or a range of the semiconductor yield, and analyze a contribution rank of each of the groups.

The technical purposes of the present disclosure are not limited to the technical purposes as mentioned above, and other technical purposes as not mentioned may be clearly understood by those skilled in the art from descriptions as set forth below.

A semiconductor yield prediction model analysis method according to one embodiment of the present disclosure may be performed by a computing device, and may comprise selecting a plurality of models having a prediction accuracy exceeding a preset threshold value, each model of the plurality of models being an artificial intelligence model configured to receive semiconductor-related data as a predictive factor and to predict a semiconductor yield using the predictive factor as an input; selecting a plurality of predictive factors commonly included in the plurality of models; determining a prediction contribution of each of the selected plurality of predictive factors based on a prediction result of each of the plurality of models; scaling the prediction contributions of the predictive factors obtained such that the prediction contributions are within a same range; and determining a contribution rank of each of the selected plurality of predictive factors based on the scaled prediction contributions.

A system for analyzing a semiconductor yield prediction model according to another embodiment of the present disclosure may comprise a processor; and a memory storing instructions, wherein the instructions are configured to, when executed by the processor, cause the processor select a plurality of models having a prediction accuracy exceeding a preset threshold value, each model of the plurality of models being an artificial intelligence model configured to receive semiconductor-related data as a predictive factor and to predict a semiconductor yield using the predictive factor as an input; select a plurality of predictive factors commonly included in the plurality of models; determine a prediction contribution of each of the selected plurality of predictive factors based on a prediction result of each of the plurality of models; scale the prediction contributions of the predictive factors obtained such that the predictive contributions are within a same range; and determine a contribution rank of each of the selected plurality of predictive factors based on the scaled prediction contributions.

A non-transitory computer-readable medium according to still another embodiment of the present disclosure may store a computer program, the computer program configured to, when executed by a processor, cause the processor to perform: select a plurality of models having a prediction accuracy exceeding a preset threshold value, each model of the plurality of models being an artificial intelligence model configured to receive semiconductor-related data as a predictive factor and to predict a semiconductor yield using the predictive factor as an input; select a plurality of predictive factors commonly included in the plurality of models; determine a prediction contribution of each of the selected plurality of predictive factors based on a prediction result of each of the plurality of models; scale the prediction contributions of the predictive factors obtained such that the predictive contributions are within a same range; and determine a contribution rank of each of the selected plurality of predictive factors based on the scaled prediction contributions.

### BRIEF DESCRIPTION OF DRAWINGS

The above and other aspects and features of the present disclosure will become more apparent by describing in detail illustrative embodiments thereof with reference to the attached drawings, in which:

FIG. 1 is a block diagram showing an example configuration of a computing system configure to perform a semiconductor manufacturing process according to at least one example embodiment of the present disclosure;

FIG. 2 is a flow chart showing an example method for analyzing a semiconductor yield prediction model according to at least one example embodiment of the present disclosure;

FIG. 3 is a flow chart specifically showing a step for selecting a plurality of predictive factors of FIG. 2.

FIG. 4 is a flow chart showing an example of a step for calculating contribution ranks of the plurality of predictive factors of FIG. 2;

FIG. 5 is a flow chart showing another example of a step for calculating contribution ranks of the plurality of predictive factors of FIG. 2;

FIG. 6 is a flow chart showing still another example of a step for calculating contribution ranks of the plurality of predictive factors of FIG. 2;

FIG. 7 shows an example of a prediction contribution calculation result of each of the predictive factors according to at least one example embodiment of the present disclosure;

FIG. 8 shows an example of a calculation result of an average magnitude of a prediction contribution corresponding to FIG. 7; and

FIG. 9 shows an example of a calculation result of a contribution rank according to at least one example embodiment of the present disclosure.

### DETAILED DESCRIPTIONS

Hereinafter, preferred embodiments of the present disclosure will be described in detail with reference to the attached drawings. Advantages and features of the present disclosure, and a method of achieving the advantages and features will become apparent with reference to embodiments described later in detail together with the accompanying drawings. However, embodiments of the present disclosure are not limited to the embodiments as disclosed below, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure gist of the present disclosure. Examples of various embodiments are illustrated and described further below. Further, it will be understood that the functional elements, like those indicated by the use of the suffixes “-or” and “-er”, and/or the like mean a unit that is configured to process at least one function or operation, which may be implemented in and/or enabled by processing circuitry such as hardware, software, or a combination of hardware and software. For example, the processing circuitry may include, but is not limited to, a central processing unit (CPU), an application processor (AP), an arithmetic logic unit (ALU), a graphic processing unit (GPU), a digital signal processor, a microcomputer, a field programmable gate array (FPGA), a System-on-Chip (SoC) a programmable logic unit, a microprocessor, an application-specific integrated circuit (ASIC), etc. It will be understood that the description herein is not intended to limit the claims to the specific embodiments described. On the contrary, it is intended to cover alternatives, modifications, and equivalents as may be included within the spirit and scope of the present disclosure as defined by the appended claims.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise.

Additionally, in describing the components of the present disclosure, terms such as first, second, A, B, a, and b may be used. These terms are only used to distinguish one component from another component, and the nature, sequence, order, or number of the component are not limited by the term. It should be understood that when a component is described as being “connected,” “coupled,” or “combined” to another component, the component may be directly connected, coupled, or combined to another component, still another component may be “interposed” therebetween, and thus the component may be connected, coupled, or combined to another component via the sill another component.

It will be further understood that the terms “comprise”, “comprising”, “include”, and “including” as used herein specify the presence of the stated features, steps, operations, elements, and/or components, but do not preclude the presence or addition of one or more other features, steps, operations, elements, components, and/or portions thereof.

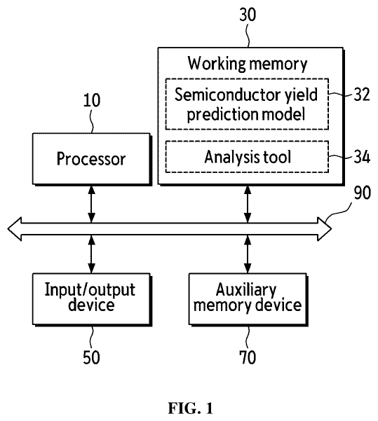

FIG. 1 is a block diagram showing an example configuration of a computing system for performing a semiconductor manufacturing process according to at least one example embodiment of the present disclosure. Referring to FIG. 1, the computing system may include a processor 10 and a working memory 30. The computing system may further include (and/or be configured to be connected to) an input/output device 50 and an auxiliary memory device 70. The computing system of FIG. 1 may be provided as a dedicated device configured to train a model for predicting a semiconductor yield in a semiconductor manufacturing process, to predict the yield using the trained model, and to analyze a yield prediction result. The computing system of FIG. 1 may be equipped with various design and verification simulation programs. In at least some embodiments, the computing system of FIG. 1 may be included in and/or configured to control a semiconductor processing apparatus such that a production of a semiconductor device and/or the corresponding subsequent series of processes (e.g., development, etching, cleaning, or the like) are controlled based on the semiconductor manufacturing process. As such, a semiconductor device may be produced using the semiconductor manufacturing process confirmed based on the results of the yield prediction result. Additionally, in at least some embodiments, the computing system of FIG. 1 may adjust (or proposed adjustments to) the semiconductor manufacturing process to increase the yield based on the training, thereby increasing the yield of the semiconductor manufacturing process. In at least some embodiments, the computing system of FIG. 1 may automatically avoid semiconductor manufacturing processes or paths with yields below a threshold, thereby preventing the waste of resources; and/or the computing system of FIG. 1 may rank potential semiconductor manufacturing processes based on yield and control the operation of the semiconductor device to perform the processes in an order wherein the yield would be the greatest and/or improved.

The processor 10 is configured to execute software (application program, operating system, device drivers) to be executed in the computing system. Therefore, the processor 10 may execute an operating system (OS, not shown) loaded into the working memory 30; and/or the processor 10 may execute various application programs based on the operating system (OS). For example, the processor 10 is configured to execute a semiconductor yield prediction model 32 and/or an analysis tool 34 in the working memory 30. The processor 10 may be and/or include, for example, at least one of a CPU (Central Processing Unit), an MPU (Micro Processor Unit), an MCU (Micro Controller Unit), a GPU (Graphics Processing Unit), or other types of processors.

The operating system (OS) or the application programs may be loaded into the working memory 30. When the computing system is booted, an OS image (not shown) stored in the auxiliary memory device 70 may be loaded into the working memory 30 based on a boot sequence. The operating system (OS) may support all input/output operations of the computing system. The application programs may be loaded into the working memory 30 under selection by a user or for providing a basic service. In at least some embodiments, the semiconductor yield prediction model 32 and/or the analysis tool 34 may be loaded into the working memory 30 from the auxiliary memory device 70. Furthermore, in addition to the semiconductor yield prediction model 32 and the analysis tool 34 as illustrated in FIG. 1, a layout design tool and/or an optical proximity correction (OPC) tool may be loaded into the working memory 30 from the auxiliary memory device 70.

The semiconductor yield prediction model 32 is configured to receive semiconductor-related data as an input and to generate and output a predicted the semiconductor yield as an output. For example, the semiconductor yield prediction model 32 may be embodied as an artificial intelligence model that is configured to receive the semiconductor-related data as a predictive factor and to predict the semiconductor yield based on the predictive factor. In at least some embodiments, the semiconductor-related data may include data related to semiconductor manufacturing equipment, and/or sensor data, measurement data, production data, and semiconductor quality data related to the semiconductor manufacturing process. The semiconductor-related data may be classified into data of various types. For example, the semiconductor-related data may be classified into numerical data, categorical data (e.g., process recipe information), virtual measurement-related data, etc. This may be equally applied to a classification of the predictive factors based on types as described below.

The semiconductor yield prediction model 32 according to at least one example embodiment of the present disclosure may be embodied as a regression model. For example, the regression model may be embodied as one of a DNN (deep neural network), a gradient-boosted decision tree, a random forest, and/or the like. However, the present disclosure is not limited thereto, and the semiconductor yield prediction model 32 may be embodied using various forms of artificial intelligence models.

In at least some embodiments, in order to predict the semiconductor yield using the semiconductor yield prediction model 32, the semiconductor-related data used as the predictive factor may be preprocessed. For example, the preprocessing of the semiconductor-related data may be performed by a computer program for processing of data loaded into the working memory 30. In this regard, the preprocessing of the semiconductor-related data may include interpolating a missing value of the semiconductor-related data and/or normalizing the semiconductor-related data. Thereafter, the semiconductor yield output through the semiconductor yield prediction model 32 may be provided to the analysis tool 34.

The analysis tool 34 is configured to calculate a prediction contribution of each of the predictive factors to a prediction result of the semiconductor yield prediction model 32. For this purpose, the analysis tool 34 may be configured to apply a SHAP (Shapley Additive exPlanations) algorithm to the semiconductor yield prediction model 32. The SHAP algorithm is one of the methods for analyzing the prediction result of the artificial intelligence model, and is configured to calculate the contribution of each factor to the prediction result of the model to enable the explanation of the prediction result of the model based on the calculation result. In some embodiments, the analysis tool 34 may be configured to calculate the prediction contribution of the predictive factor per each wafer. In some further embodiments, the analysis tool 34 may be configured to calculate the prediction contribution of the predictive factor in an entire wafer.

Specifically, in the SHAP algorithm, a contribution of a factor ‘i’ to the prediction result of the model may be calculated based on a difference between a prediction result when the factor is present and a prediction result when the factor is not present. The contribution value calculated through the SHAP algorithm may indicate an extent to which each of the factors contributes to the prediction result of the model in a positive or negative direction. When the prediction contribution of a specific predictive factor has the positive direction, this may mean that the semiconductor yield increases as a value of the specific predictive factor increases. Conversely, when the prediction contribution of the specific predictive factor has the negative direction, this may mean that the semiconductor yield increases as the value of the specific predictive factor decreases.

Next, the analysis tool 34 may be configured to select a plurality of models whose prediction accuracy is higher than or equal to a preset threshold from among the semiconductor yield prediction models 32. For example, the prediction accuracy may be determined based on a R-squared value of the regression model. This is because when the SHAP algorithm is applied to the model exhibiting the prediction accuracy lower than the preset prediction accuracy, it is difficult to trust the analysis result of the SHAP algorithm. Thereafter, the analysis tool 34 may be configured to select a plurality of predictive factors that are commonly included in the selected plurality of models. In some embodiments, the analysis tool 34 may be configured to select a plurality of predictive factors that are included in all of the selected plurality of models.

Alternatively, in some further embodiments, the analysis tool 34 may be configured to select a plurality of predictive factors that are commonly included in pre-selected some of models among the selected plurality of models. In such cases, selecting the plurality of predictive factors included in some models may correspond to a case where the factor whose the contribution is to be analyzed is not present in all models but is present only in some models.

After selecting the plurality of predictive factors commonly included in the plurality of models, the analysis tool 34 may be configured to obtain the prediction contribution of each of the predictive factors as calculated through the SHAP algorithm. Then, the analysis tool 34 may be configured to perform scaling of the obtained contributions of the predictive factors to the prediction result of the model so that the obtained contributions of the predictive factors to the prediction result of the model are within the same range. In this regard, the scaling may refer to normalizing the prediction contributions as calculated through the SHAP algorithm so as to be within the same range while maintaining the directionality thereof. For example, MaxAbs, L2/L1 norm scaling, etc. may be used as a scaling scheme. However, the present disclosure is not limited thereto. Due to the scaling, influence of an analysis result of a specific model may be prevented from (or inhibited from) becoming excessively large.

Furthermore, the analysis tool 34 may be configured to assign a weight to each of the selected plurality of models. In this regard, the assigned weight may be used in calculating a weighted average in a calculation process of a contribution rank as described below. For example, the analysis tool 34 may be configured to assign a greater weight to a model including a larger number of types of predictive factors or a model having high prediction accuracy, and to assign a relatively smaller weight to the remaining models. In this regard, in at least some embodiments, a sum of the assigned weights may be equal to 1.

In at least some embodiments, thereafter, the analysis tool 34 is configured to calculate the contribution rank of each of the selected plurality of predictive factors based on each of the scaled prediction contributions thereof. In some embodiments, the contribution rank may be determined based on an absolute average of a weighted sum of the prediction contributions as calculated on wafers using the SHAP algorithm. In this regard, the absolute average may refer to a value obtained by dividing the weighted sum by the number of wafers. Alternatively, in some further embodiments, the contribution rank may be determined based on a weighted average of ranks of magnitudes of the prediction contributions as calculated on wafers using the SHAP algorithm. Hereinafter, embodiments of calculating the contribution rank will be described.

First, at least one example embodiment of determining the contribution rank of each of the selected plurality of predictive factors based on the absolute average of the weighted sum of the prediction contributions calculated on the wafers is described. In these examples, the analysis tool 34 is configured to calculate a magnitude of the scaled prediction contribution of each of the selected plurality of predictive factors input to each of the models and on each of the wafers. The magnitude of the prediction contribution may refer to an absolute value of the prediction contribution, and may refer to the contribution value which is calculated as a result of applying the SHAP algorithm and from which the directionality has been removed. Thereafter, the analysis tool 34 may calculate the weighted sum of the prediction contribution magnitudes input to each of the plurality of models as calculated on the wafers, based on a preset (or otherwise determined) weight allocated to each of the plurality of models, and then divide the calculated weighted sum by the number of wafers to calculate the absolute average of the weighted sum. Then, a final contribution rank of each of the selected plurality of predictive factors may be calculated based on the calculated absolute average.

Second, at least one example embodiment of determining the contribution rank of each of the selected plurality of predictive factors based on the weighted average of the ranks of the magnitudes of the prediction contributions is described. In these examples, the analysis tool 34 may be configured to calculate the magnitude of the scaled prediction contribution of each of the selected plurality of predictive factors input to each of the plurality of models, and then calculate the rank of the prediction contribution of each predictive factor input to each of the plurality of models, based on the calculated magnitude. Then, the analysis tool 34 may be configured to calculate the weighted average of the prediction contribution ranks respectively corresponding to the models, based on the preset weight allocated to each of the plurality of models. Then, the final contribution rank of each of the selected plurality of predictive factors may be calculated based on the calculated weighted average.

In at least one example, the final contribution rank may be calculated per a group of predictive factors grouped based on a preset criterion. In some embodiments, the plurality of predictive factors may be grouped based on a preset range of the semiconductor yield predicted according to the semiconductor yield prediction model 32. For example, the plurality of predictive factors may be grouped into a group of predictive factors to be input to a model in which the semiconductor yield is predicted to be in a range of 90% exclusive to 100% inclusive, and into a group of predictive factors to be input to a model in which the semiconductor yield is predicted to be in a range of 80% exclusive to 90% inclusive. Thereafter, the contribution rank of each group may be calculated according to the above-described embodiments. Therefore, it may be easy to identify the factor that significantly affects the semiconductor yield in the specific range.

In some further embodiments, the plurality of predictive factors may be grouped based on types of predictive factors. The types of predictive factors correspond to the types of semiconductor-related data as described above. The type of the predictive factor may belong to one selected from among a numeric predictive factor, a categorical predictive factor, and a virtual measurement (VM)-related predictive factor. For example, since the contribution ranks of the numeric predictive factors, the contribution ranks of the categorical predictive factors, and the contribution ranks of the virtual measurement-related predictive factors may be calculated. Thus, it may be relatively easy to identify the factor that significantly affects the semiconductor yield based on the type of the factor.

In some embodiments, the analysis tool 34 is configured to display a result of visualizing the final contribution rank as calculated in this manner in a form of a graphical user interface (GUI) on an output device 50 and/or a user terminal (not shown). In this regard, the user terminal may be a computing device (e.g., a smartphone, a desktop, a laptop, etc.) used by a manager of the semiconductor equipment or an engineer of the semiconductor manufacturing process to monitor the semiconductor yield, and may communicate with the computing system of FIG. 1. For example, the visualized result may be sent to the user of the user terminal by email.

The visualized result displayed in the form of the GUI may include the analysis result of the contribution rank. In some embodiments, the analysis result may include whether to adjust a corresponding factor of each of the semiconductor manufacturing process and the semiconductor manufacturing equipment as determined based on the contribution rank. In this regard, the corresponding factor represents an adjustable factor related to the semiconductor manufacturing process or the semiconductor manufacturing equipment among the predictive factors to be input to the semiconductor yield prediction model 32. Specifically, whether to adjust the corresponding factor may indicate whether to increase or decrease the factor in order to improve the yield in consideration of the contribution rank.

For example, a predictive factor that has a high rank based on the analysis result of the contribution rank and has a negative direction based on the SHAP algorithm application result may be expected to decrease the yield, and thus may be adjusted to be decreased. However, a predictive factor that has a high rank based on the analysis result of the contribution rank and has a positive direction based on the SHAP algorithm application result may be expected to increase the yield and thus may be adjusted to be increased.

In some embodiments, whether to adjust the corresponding factor may be determined based on a correlation between the selected plurality of predictive factors. For example, when a factor with a high rank based on the analysis result of the contribution rank has a significant correlation with another factor, whether to adjust the corresponding factor may indicate that the adjustment of another factor having the significant correlation with the corresponding factor along with the adjustment of the corresponding factor are beneficial.

In at least some embodiments, the analysis tool 34 is configured to receive a list of wafers on which calculation of the contribution rank of the predictive factor is to be performed. Furthermore, the analysis tool 34 may be configured to receive a list of predictive factors which are not to be subjected to evaluation from among the predictive factors. For example, a factor which is not to be subjected to the evaluation may be a factor that has already been identified as having a high contribution, or a factor that has been pre-identified as having a low importance level. Then, the analysis tool 34 may be configured to further receive a list of wafers on which the calculation of the contribution rank of the predictive factor is not to be performed. Furthermore, the analysis tool 34 may be configured to further receive a list of other parameters which may be analysis targets as well as the yield, and may be configured to equally apply the analysis method (i.e., the calculation method of the contribution rank of the predictive factor) as described above to the artificial intelligence model that predicts the parameter.

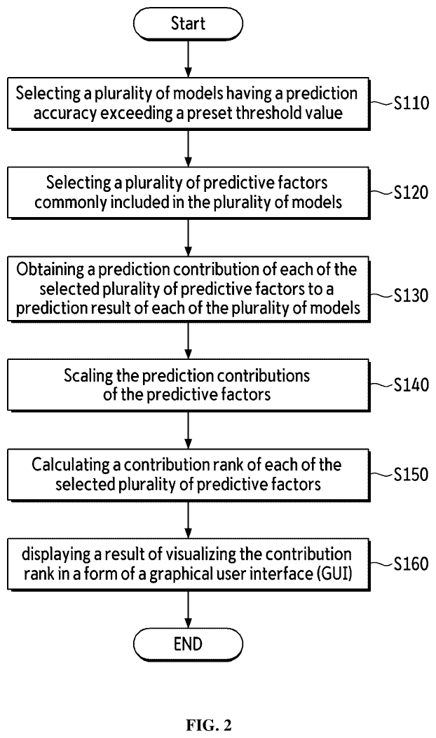

According to the above-described embodiments, the analysis tool 34 may be configured to output a list in which the average magnitudes of the predictive factors are arranged in an order of the magnitude, the contribution of the predictive factor based on each of the semiconductor manufacturing processes, and a list of semiconductor manufacturing processes in which the predictive factor has a high contribution. Then, when a predictive factor that is not detected during a specific period is newly detected, the analysis tool 34 may be configured to output information on the new factor. Embodiments related to the analysis of the above-described semiconductor yield prediction model are described below with reference to FIG. 2 to FIG. 9.

For example, the working memory 30 may be a volatile memory such as a dynamic random access memory (DRAM), a static random access memory (SRAM), or a nonvolatile memory such as a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), etc.

The input/output device 50 is configured to control user input and output from user interface devices. For example, the input/output device 50 may include a keyboard or a monitor to receive information from a designer. Using the input/output device 50, the designer may receive information about a semiconductor area identified as having operating characteristics or data routes to be adjusted. The processing process and processing results of the semiconductor yield prediction model 32 and/or the analysis tool 34 may be displayed through the input/output device 50.

The auxiliary memory device 70 is configured to act as a storage medium of the computing system. The auxiliary memory device 70 may store therein application programs, the operating system image, and various data. The auxiliary memory device 70 may be embodied as a memory card (MMC, eMMC, SD, MicroSD, etc.) or a hard disk drive (HDD). The auxiliary memory device 70 may include a NAND flash memory having a large storage capacity. Alternatively, the auxiliary memory device 70 may include a next-generation nonvolatile memory such as PRAM, MRAM, ReRAM, FRAM, or a NOR flash memory.

A system interconnector 90 may be embodied as a system bus for providing a network within the computing system. The processor 10, the working memory 30, the input/output device 50, and the auxiliary memory device 70 may be electrically connected to each other and exchange data with each other through the system interconnector 90. However, the configuration of the system interconnector 90 is not limited to the description as described above, and may further include mediation means for efficient management.

FIG. 2 is a flow chart of an example of a semiconductor yield prediction model analysis method according to at least one example embodiment of the present disclosure. For reference, FIG. 2 and FIGS. 3 to 6 as described below represent steps/operations of the semiconductor yield prediction model analysis method performed in the computing system of FIG. 1. Therefore, in the descriptions as set forth below, it may be understood that when a subject of a specific step/operation is omitted, the specific step/operation is performed in the computing system of FIG. 1.

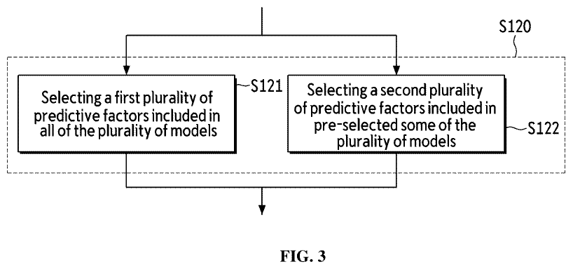

In step S110, a plurality of models having a prediction accuracy level greater than a threshold value may be selected. In this regard, each of the plurality of models may be an artificial intelligence model (e.g., embodied as one of DNN, gradient boost decision tree, and random forest) that receives the semiconductor-related data (e.g., semiconductor equipment data, sensor data, measurement data, production data, and quality data, etc.) as the predictive factor and predicts the semiconductor yield using the predictive factor. In step S120, a plurality of predictive factors that are commonly included in the plurality of models may be selected. The following describes step S120 with reference to FIG. 3.

FIG. 3 is a flowchart specifically showing step S120 of selecting the plurality of predictive factors of FIG. 2. Referring to FIG. 3, in step S121, a first plurality of predictive factors that are included in all of the plurality of models may be selected. Alternatively, in step S122, a second plurality of predictive factors that are included in some pre-selected models among the plurality of models may be selected. That is, step S121 corresponds to at least one example embodiment of selecting the predictive factor that is used as input data to all of the semiconductor yield prediction models. Step S122 corresponds to at least one example embodiment of selecting a predictive factor that is used as input data to some (e.g., a subset) of the semiconductor yield prediction models. For example, at least one example embodiment of step S122 may be performed when it is desired to calculate a contribution rank of a specific predictive factor, but the specific predictive factor is not included in all of the semiconductor yield prediction models as selected in step S110.

Returning to FIG. 2, in step S130, a prediction contribution of each of the selected plurality of predictive factors to a prediction result of each of the plurality of models may be obtained. In this regard, the prediction contribution may be a result calculated by applying the SHAP (Shapley Additive exPlanations algorithm) to each of the plurality of models. Furthermore, the prediction contribution calculated using the SHAP algorithm may have either a positive direction or a negative direction. In some cases, the prediction contribution may be a value calculated on each of the wafers, or a value calculated on an entire wafer.

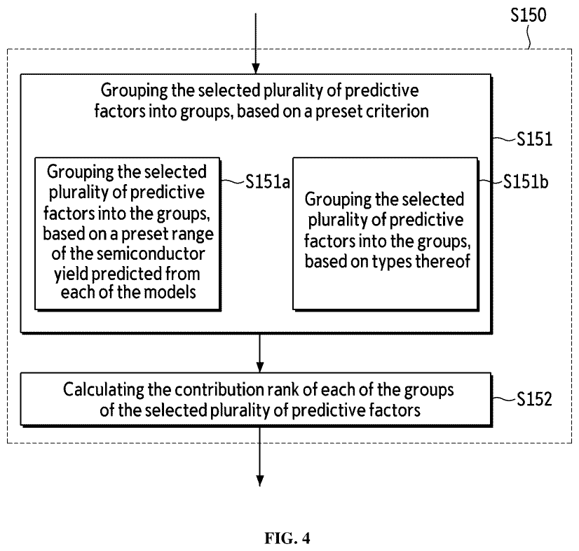

In step S140, the obtained prediction contributions of the factors to a prediction result of each model may be scaled to be within the same range. In this regard, the scaling may mean normalization of the contributions such that the directionality of the contribution (e.g., whether the contribution has the positive or negative direction) is maintained, which is not the case for general normalization. In step S150, the contribution rank of each of the selected of the plurality of predictive factors may be calculated based on the scaled prediction contribution. Hereinafter, referring to FIG. 4 to FIG. 6, embodiments of calculating the contribution ranks of the plurality of predictive factors will be described.

FIG. 4 is a flowchart showing an example of step S150 of calculating the contribution ranks of the plurality of predictive factors of FIG. 2. Referring to FIG. 4, in step S151, the selected plurality of predictive factors may be grouped according to a preset criterion.

More specifically, in step S151a, the plurality of predictive factors may be grouped based on a preset range of the semiconductor yield predicted by each model. For example, the preset range may include a range of 90% exclusive to 100% inclusive of the semiconductor yield, a range of 80% exclusive to 90% inclusive of the semiconductor yield, a range of 70% exclusive to 80% inclusive of the semiconductor yield, etc. However, the present disclosure is not limited thereto. Alternatively, in step S151b, the plurality of predictive factors may be grouped based on a type of the predictive factor. In this regard, the type of the predictive factor may be one of a numeric predictive factor, a categorical predictive factor, and a virtual measurement-related predictive factor.

Thereafter, in step S152, the contribution rank of each of the groups of the selected plurality of predictive factors may be calculated. For example, when the selected plurality of predictive factors are grouped based on the preset range of the semiconductor yield predicted by each model, the contribution rank of the predictive factor may be calculated based on each range of the semiconductor yield. Thus, which predictive factor is the most important for increasing the yield to a next range may be determined. Alternatively, when the plurality of predictive factors are grouped based on the type of the predictive factor, the contribution rank of each of the numerical predictive factor, the categorical predictive factor, and the virtual measurement-related predictive factor may be calculated. Thus, the most important type of the predictive factor among the types of factors may be determined.

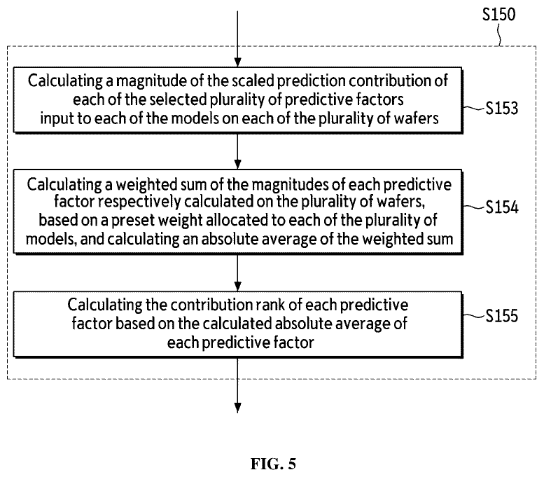

FIG. 5 is a flowchart showing another embodiment of step S150 of calculating the contribution ranks of the plurality of predictive factors of FIG. 2. Referring to FIG. 5, in step S153, the magnitude of the scaled prediction contribution of each of the selected plurality of predictive factors input to each of the plurality of models may be calculated on each of wafers. In this regard, the magnitude of the prediction contribution may represent the absolute value of the prediction contribution regardless of the positive or negative direction. In step S154, based on the weight allocated to each of the plurality of models, the absolute average of the weighted sum of the magnitudes of the scaled prediction contributions as calculated on the wafers may be calculated. For example, the analysis tool 34 may assign a greater weight to a model including a larger number of types of predictive factors or a model having high prediction accuracy. In step S155, the contribution rank may be calculated based on the calculated absolute average. That is, according to at least one example embodiment of FIG. 5, the contribution rank may be determined as the absolute average of the weighted sum of the absolute values of the contributions calculated on the wafers through the SHAP algorithm.

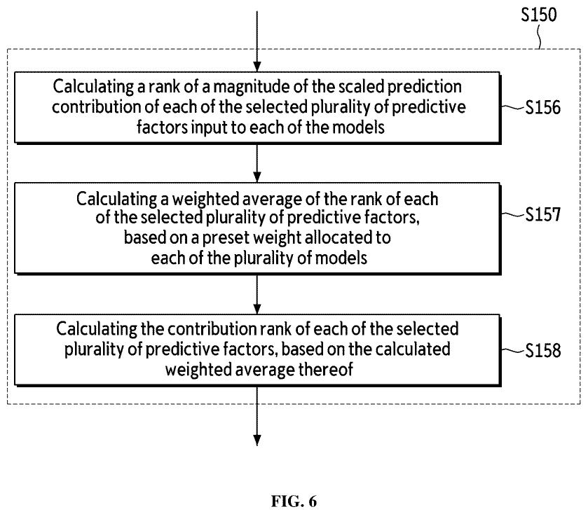

FIG. 6 is a flowchart showing another embodiment of step S150 of calculating the contribution ranks of the plurality of predictive factors of FIG. 2. Referring to FIG. 6, in step S156, the magnitude of the scaled prediction contribution of each of the selected plurality of predictive factors input to each of the plurality of models may be calculated, and then the rank of the magnitude thereof may be calculated. That is, in step S156, the absolute value of the prediction contribution may be calculated, and then the rank of the absolute value may be calculated. In step S157, a weighted average of the rank may be calculated based on the preset weight allocated to each of the plurality of models. In step S158, the contribution rank may be calculated based on the calculated weighted average. That is, according to at least one example embodiment of FIG. 6, the contribution rank may be determined based on the weighted average of the rank of the absolute value of the contribution calculated through the SHAP algorithm.

Returning to FIG. 2, in step S160, the result of visualizing the contribution rank may be displayed in the form of the graphical user interface GUI on the user terminal. For example, the user terminal may be a computing device (e.g., a smartphone, a desktop, a laptop, etc.) used by a manager of the semiconductor equipment or an engineer of the semiconductor manufacturing process to monitor the semiconductor yield. For example, the visualized result may be sent to the user of the user terminal by email.

In one example, the visualized result of step S160 may include the analysis result of the contribution rank. The analysis result may include whether to adjust the corresponding factor of each of the semiconductor manufacturing process and the semiconductor manufacturing equipment (i.e., a factor of each of the process and the equipment corresponding to the predictive factor) determined based on the contribution rank. Specifically, whether to adjust the corresponding factor may indicate whether to increase or decrease the factor in order to improve the yield in consideration of the contribution rank. For example, whether to adjust the corresponding factor may indicate whether to further increase the factor with a high contribution rank.

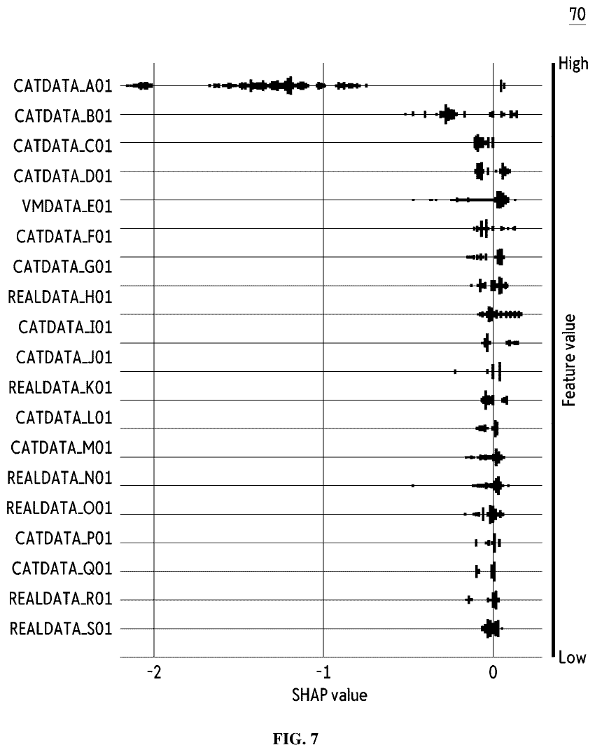

Hereinafter, with reference to FIG. 7 to FIG. 9, the prediction contribution calculation result and the contribution rank calculation result according to at least one example embodiment of the present disclosure are reviewed.

FIG. 7 shows an example of the prediction contribution calculation result based on the predictive factor according to at least one example embodiment of the present disclosure.

Referring to a graph 70 of FIG. 7, the contribution of each of the categorical predictive factor CATDATA, the virtual measurement-related predictive factor VMDATA, and the numerical predictive factor REALDATA as calculated by the SHAP algorithm is shown. CATDATA_A01 has the highest contribution in the negative direction. This may mean that CATDATA_A01 has the largest contribution in reducing the semiconductor yield.

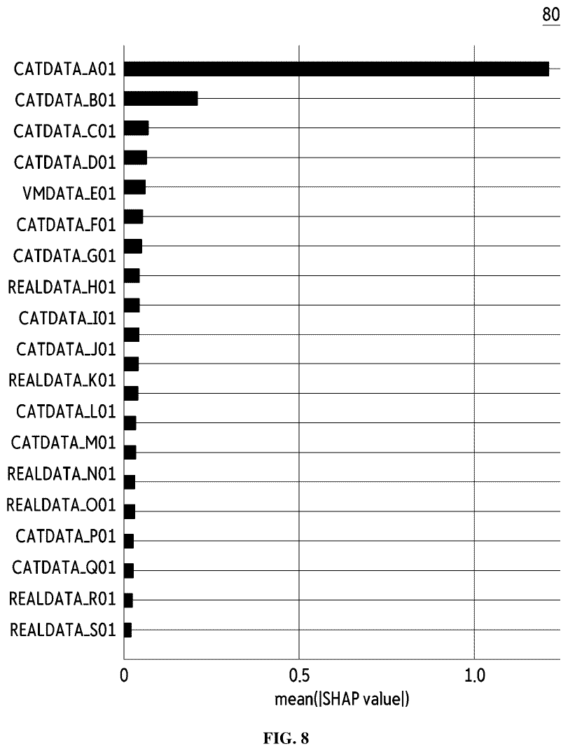

FIG. 8 shows an example of an average calculation result of a magnitude of the prediction contribution corresponding to FIG. 7. Referring to a graph 80 of FIG. 8, the average value of the magnitude (absolute value) of each of the categorical predictive factor CATDATA, the virtual measurement-related predictive factor VMDATA, and the numeric predictive factor REALDATA as calculated by the SHAP algorithm is shown. For example, the average of FIG. 8 may correspond to a weighted average based on the weight allocated to each model. That is, the graph 80 of FIG. 8 may correspond to the result of the graph 70 of FIG. 7 from which the directionality has been removed. It may be identified that even after the directionality has been removed, CATDATA_A01 still has the highest contribution.

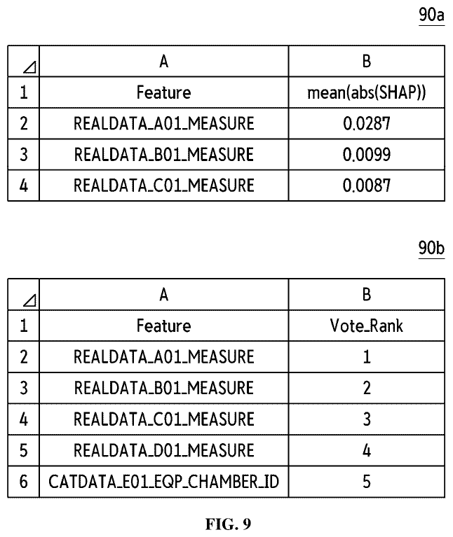

FIG. 9 shows an example of the calculation result of the contribution rank according to at least one example embodiment of the present disclosure. Referring to FIG. 9, a table 90a indicates that the final contribution rank of the factor is determined based on the absolute average of the weighted sum of the magnitudes of the prediction contributions of the factor as calculated on the wafers, which may correspond to the embodiment of FIG. 5. A table 90b indicates that the final contribution rank of the factor is determined based on the weighted average of the rank of the prediction contribution of the factor, based on the weight allocated to each model, which may correspond to the embodiment of FIG. 6. For example, all of the graphs and tables of FIGS. 7 to 9 may be included in the visualizing result of the contribution rank.

In one example, the semiconductor yield prediction model analysis method according to at least one example embodiment of the present disclosure may be executed in the computing system of FIG. 1. For example, the analysis tool 34 of FIG. 1 may be a non-transitory computer-readable medium that may non-transitorily store therein one or more computer programs. The computer program may include one or more instructions. When the instructions are loaded into the working memory 30, the instructions cause the processor 10 to perform operations/methods according to various embodiments of the present disclosure. That is, the processor 10 may execute the loaded one or more instructions to perform the operations/methods according to various embodiments of the present disclosure.

For example, the computer program non-temporarily stored in the analysis tool 34 may be configured to perform selecting a plurality of models having a prediction accuracy exceeding a preset threshold value, wherein each of the plurality of models is an artificial intelligence model configured to receive semiconductor-related data as a predictive factor and predict a semiconductor yield using the predictive factor; selecting a plurality of predictive factors commonly included in the plurality of models; obtaining a prediction contribution of each of the selected plurality of predictive factors to a prediction result of each of the plurality of models; scaling the prediction contributions of the predictive factors obtained on each of the models so as to be within the same range; and calculating a contribution rank of each of the selected plurality of predictive factors based on the scaled prediction contributions.

Conventionally, when a single semiconductor yield prediction analysis model is used, the contribution of the predictive factor may be calculated to vary when the training data slightly varies or a hyperparameter slightly varies. Thus, according to at least one example embodiment of the present disclosure, in order to solve the above problem, the contribution analysis results on various semiconductor yield prediction analysis models may be collected. In addition, according to at least one example embodiment of the present disclosure, based on the contribution analysis results collected from the plurality of semiconductor yield prediction analysis models, the prediction contribution ranks of the predictive factors with consistent contributions to the prediction result of each model may be set to be high, so that the reliability of the contribution analysis result may be secured.

Various embodiments of the present disclosure and the effects according to those embodiments have been mentioned above with reference to FIG. 1 to FIG. 9. The effects according to the technical idea of the present disclosure are not limited to the effects as mentioned above, and other effects not mentioned may be clearly understood by those skilled in the art from the above descriptions.

All the components that constitute the embodiment of the present disclosure are described as being combined with each other or operating in combination with each other. However, the present disclosure is not necessarily limited to this embodiment. In other words, within the scope of the purpose of the present disclosure, all of the components may operate in a selective combination manner of at least two thereof with each other.

Although the operations are shown as being executed in a specific order in the drawings, it should not be understood that the operations should be performed in the specific order as shown or in a sequential order or that all illustrated operations should be performed to obtain the desired result.

Although embodiments of the present disclosure have been described with reference to the accompanying drawings, embodiments of the present disclosure are not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above is not restrictive but illustrative in all respects.

What is claimed is:

1. A method for analyzing a semiconductor yield prediction model, the method being performed by a computing device, the method comprising:
selecting a plurality of models having a prediction accuracy exceeding a preset threshold value, each model of the plurality of models being an artificial intelligence model configured to receive semiconductor-related data as a predictive factor and to predict a semiconductor yield using the predictive factor as an input;
selecting a plurality of predictive factors commonly included in the plurality of models;
determining a prediction contribution of each of the selected plurality of predictive factors based on a prediction result of each of the plurality of models;
scaling the prediction contributions of the predictive factors obtained such that the prediction contributions are within a same range; and
determining a contribution rank of each of the selected plurality of predictive factors based on the scaled prediction contributions.

2. The method of claim 1, wherein each of the plurality of models is a regression model embodied as at least one of a deep neural network (DNN), a gradient-boosted decision tree, or a random forest.

3. The method of claim 1, wherein the selecting the plurality of predictive factors includes:
determining whether a specific predictive factor, of the selected plurality of predictive factors, is not commonly included in all of the plurality of models, and
selecting a first plurality of predictive factors included in all of the plurality of models, or selecting a second plurality of predictive factors included in a pre-selected subset of the plurality of models based on a result of the determination of whether the specific predictive factor is included in all of the plurality of models.

4. The method of claim 1, wherein the obtaining the prediction contribution includes:
applying a SHAP (Shapley Additive exPlanations) algorithm to each of the plurality of models,
wherein the prediction contribution has either a positive direction or a negative direction.

5. The method of claim 1, wherein the determining the contribution rank of each of the selected plurality of predictive factors includes:
grouping the selected plurality of predictive factors into groups based on a preset criterion; and
determining the contribution rank of each of the groups of the selected plurality of predictive factors.

6. The method of claim 5, wherein the grouping of the selected plurality of predictive factors into the groups includes
grouping the selected plurality of predictive factors into the groups based on a preset range for the semiconductor yield predicted from each of the models.

7. The method of claim 5, wherein the grouping of the selected plurality of predictive factors into the groups includes
grouping the selected plurality of predictive factors into the groups based on at least one of a numeric predictive factor, a categorical predictive factor, or a virtual measurement (VM)-related predictive factor.

8. The method of claim 1, wherein the determining the prediction contribution includes obtaining the prediction contribution of each of the selected plurality of predictive factors on each of a plurality of wafers,
wherein the determining the contribution rank of each of the selected plurality of predictive factors includes:
determining a magnitude of the scaled prediction contribution of each of the selected plurality of predictive factors input to each of the models on each of the plurality of wafers;
determining a weighted sum of the magnitudes of each predictive factor respectively determined for the plurality of wafers, based on a preset weight allocated to each of the plurality of models;
dividing the determined weighted sum by a number of the plurality of wafers to determine an absolute average of each predictive factor; and
determine the contribution rank of each predictive factor based on the absolute average of each predictive factor.

9. The method of claim 1, wherein the determining the contribution rank of each of the selected plurality of predictive factors includes:
determining a rank of a magnitude of the scaled prediction contribution of each of the selected plurality of predictive factors input to each of the models;
determining a weighted average of the rank of each of the selected plurality of predictive factors, based on a preset weight allocated to each of the plurality of models; and
determining the contribution rank of each of the selected plurality of predictive factors, based on the weighted average thereof.

10. The method of claim 1, further comprising:
displaying a result of visualizing the contribution rank in a form of a graphical user interface (GUI) on a user terminal,
wherein the displayed result includes an analysis result of the contribution rank, and
wherein the analysis result includes whether to adjust a corresponding factor of each of a semiconductor manufacturing process and semiconductor manufacturing equipment, the analysis result determined based on the contribution rank.

11. The method of claim 10, wherein whether to adjust the corresponding factor is determined based on a correlation between the selected plurality of predictive factors.

12. A system for analyzing a semiconductor yield prediction model, the system comprising:
a processor; and
a memory storing instructions,
wherein the instructions are configured to, when executed by the processor, cause the processor to
select a plurality of models having a prediction accuracy exceeding a preset threshold value, each model of the plurality of models being an artificial intelligence model configured to receive semiconductor-related data as a predictive factor and to predict a semiconductor yield using the predictive factor as an input;
select a plurality of predictive factors commonly included in the plurality of models;
determine a prediction contribution of each of the selected plurality of predictive factors based on a prediction result of each of the plurality of models;
scale the prediction contributions of the predictive factors obtained such that the predictive contributions are within a same range; and
determine a contribution rank of each of the selected plurality of predictive factors based on the scaled prediction contributions.

13. The system of claim 12, wherein each of the plurality of models is a regression model embodied as at least one of a deep neural network (DNN), a gradient-boosted decision tree, or a random forest.

14. The system of claim 12, wherein the obtaining the prediction contribution includes applying a SHAP (Shapley Additive exPlanations) algorithm to each of the plurality of models, and
wherein the prediction contribution has either a positive direction or a negative direction.

15. The system of claim 12, wherein the determining the contribution rank of each of the selected plurality of predictive factors includes:
grouping the selected plurality of predictive factors into groups, based on a preset criterion; and
determining the contribution rank of each of the groups of the selected plurality of predictive factors.

16. The system of claim 15, wherein the grouping the selected plurality of predictive factors into the groups includes
grouping the selected plurality of predictive factors into the groups, based on a preset range for the semiconductor yield predicted from each of the models.

17. The system of claim 15, wherein the grouping the selected plurality of predictive factors into the groups includes
grouping the selected plurality of predictive factors into the groups, based on at least one of a numeric predictive factor, a categorical predictive factor, or a virtual measurement (VM)-related predictive factor.

18. The system of claim 12, wherein the determining the prediction contribution includes obtaining the prediction contribution of each of the selected plurality of predictive factors on each of a plurality of wafers,
wherein the determining the contribution rank of each of the selected plurality of predictive factors includes:
determining a magnitude of the scaled prediction contribution of each of the selected plurality of predictive factors input to each of the models on each of the plurality of wafers;
determining a weighted sum of the magnitudes of each predictive factor respectively determined from the plurality of wafers, based on a preset weight allocated to each of the plurality of models;
dividing the determined weighted sum by a number of the plurality of wafers to determine an absolute average of each predictive factor; and
determining the contribution rank of each predictive factor based on the absolute average of each predictive factor.

19. The system of claim 12, wherein the determining the contribution rank of each of the selected plurality of predictive factors includes:
determining a rank of a magnitude of the scaled prediction contribution of each of the selected plurality of predictive factors input to each of the models;
determining a weighted average of the rank of each of the selected plurality of predictive factors, based on a preset weight allocated to each of the plurality of models; and
determining the contribution rank of each of the selected plurality of predictive factors, based on the weighted average thereof.

20. A non-transitory computer-readable medium storing a computer program, the computer program configured to, when executed by a processor, cause the processor to:
select a plurality of models having a prediction accuracy exceeding a preset threshold value, each model of the plurality of models being an artificial intelligence model configured to receive semiconductor-related data as a predictive factor and to predict a semiconductor yield using the predictive factor as an input;
select a plurality of predictive factors commonly included in the plurality of models;
determine a prediction contribution of each of the selected plurality of predictive factors based on a prediction result of each of the plurality of models;
scale the prediction contributions of the predictive factors obtained such that the predictive contributions are within a same range; and
determine a contribution rank of each of the selected plurality of predictive factors based on the scaled prediction contributions.
